(19) United States
(12) Patent Application Publication
(10) Pub. No.: US 2026/0134254 A1
(43) Pub. Date: May 14, 2026

(54) ARTIFICIAL INTELLIGENCE (AI) SYSTEMS USING LAYERED FOUNDATION MODELS WITH REAL-TIME ADAPTING ROUTING, AND APPARATUSES, METHODS, AND NON-TRANSITORY COMPUTER-READABLE STORAGE MEDIA THEREFOR

(71) Applicant: HUAWEI TECHNOLOGIES CO., LTD., Shenzhen (CN)

(72) Inventors: Kirill Vasilevski, Toronto (CA); Dayi Lin, Toronto (CA); Ahmed E. Hassan, Kingston (CA)

(21) Appl. No.: 19/329,992

(22) Filed: Sep. 16, 2025

Related U.S. Application Data
(60) Provisional application No. 63/719,753, filed on Nov. 13, 2024.

(51) Int. Cl. G06N 3/045

(52) U.S. Cl. CPC G06N 3/045

(57) ABSTRACT

A computerized method for obtaining a foundation model (FM) output for a first request, the method includes: searching, in a first storage, for a second request similar to the first request; performing a first action if the second request is found and is suitable for processing by a first FM; and performing a second action if the second request is not found; wherein the first action includes: using the first FM to obtain the FM output; and wherein the second action includes: using the first FM to obtain a first output for the first request, using a second FM to obtain a second output as the FM output, the second FM having a greater model size and/or capability than the first FM, and storing the first request in the first storage as suitable for processing by the first FM if the first output is similar to the second output.

### CROSS-REFERENCE TO RELATED APPLICATION

This application claims the benefit of U.S. Provisional Patent Application Ser. No. 63/719,753, filed Nov. 13, 2024, the content of which is incorporated herein by reference in its entirety.

### FIELD OF THE DISCLOSURE

The present disclosure relates generally to artificial intelligence (AI) systems, and apparatuses, methods, and computer-readable storage media therefor, and in particular to AI systems using layered foundation models with real-time adapting routing, and apparatuses, methods, and non-transitory computer-readable storage media therefor.

### BACKGROUND

Foundation models (FMs) or language models (LMs) such as large language models (LLMs) are neural network models that may learn the semantics and syntax of language by encoding (sub) words into vector representations. Foundation models have been used in various artificial intelligence (AI) applications such as generative AI systems.

With advances in their capabilities, FMs have been applied to a wide variety of use cases such as open-ended conversations, planning, code generation, and question answering. Developers of FM-powered software (FMware) often face a trade-off between maximizing language model capabilities and minimizing the compute resources and costs. Choosing a larger FM that has hundreds of billions of parameters will give them greater capabilities (for example, reasoning or inference) and better quality of responses when compared to a smaller model that has only a few billion parameters. However, larger FMs require magnitudes more expensive computing resources to train and infer. At the same time, smaller FMs have shown steady improvement in their capabilities recently, often having adequate performance for common use cases such as text completion, question answering, and instruction following.

To address such a dilemma, it has become increasingly common for FMware developers to combine larger and smaller FMs as a layered architecture. For requests that can be handled by a smaller, weaker FM, the smaller FM is utilized to save computing costs. When the request is deemed beyond the capability of the smaller FM, a larger, stronger FM with greater capability is used as a fallback option to guarantee the output quality. Such a strategy can be seen on both cloud-based FMware (for example, chatbots that use GPT-3.5 by default but fall back to GPT-4 for difficult tasks) and edge-based FMware (for example, AI assistants on smartphones that use on-device small FM by default but fall back to server-side large FM when needed).

However, the effectiveness of such a layered architecture needs improvement.

### SUMMARY

According to one aspect of this disclosure, there is provided a computerized method for obtaining a foundation model (FM) output for a first request, the method comprising: obtaining a routing decision for the first request; performing a first or a second action if the routing decision selects a first or a second FM, respectively, the second FM having a greater capability than the first FM; wherein the first action comprises: forwarding the first request to the first FM to obtain the FM output; and wherein the second action comprise: searching, in a first memory, for a second request similar to the first request, and forwarding the first request to the first FM to obtain the FM output if the second request is found, or forwarding the first request to the second FM to obtain the FM output if the second request is not found.

In some embodiments, said forwarding the first request to the first FM to obtain the FM output if the second request is found comprises: if the second request is found and a corresponding first guide is found in a second memory, forwarding the first request and the first guide to the first FM to obtain the FM output; or if the second request is found and no corresponding guide is found in the second memory, forwarding the first request to the first FM without any guide from the second memory, to obtain the FM output.

In some embodiments, if the second request is not found, the computerized method further comprises: forwarding the first request to the first FM to obtain a first response; and storing the first request in the first memory if the first response and the FM output are similar.

In some embodiments, if the response and the FM output are dissimilar, the computerized method further comprises: obtaining a second guide from the second memory or the second FM; forwarding the first request and the second guide to the first FM to obtain a second response; and storing the first request in the first memory and the second guide in the second memory if the second response and the FM output are similar.

In some embodiments, if the second response and the FM output are dissimilar, the computerized method further comprises: storing the first request in the first memory with an indication for associating with the second FM.

In some embodiments, if the response and the FM output are dissimilar, the computerized method further comprises: obtaining a second guide from the second memory; forwarding the first request and the second guide to the first FM to obtain a second response; and performing a third action if the second response and the FM output are similar or performing a fourth action if the second response and the FM output are dissimilar; wherein the third action comprises: storing the first request in the first memory and the second guide in the second memory; and wherein the fourth action comprises: obtaining a third guide from the second FM, forwarding the first request and the third guide to the first FM to obtain a third response, and storing the first request in the first memory and the third guide in the second memory if the third response and the FM output are similar.

In some embodiments, if the third response and the FM output are dissimilar, the computerized method further comprises: storing the first request in the first memory with an indication for associating with the second FM.

According to one aspect of this disclosure, there is provided a computerized method for obtaining a foundation model (FM) output for a first request, the method comprising: searching, in a first storage, for a second request similar to the first request; performing a first action if the second request is found and is suitable for processing by a first FM; and performing a second action if the second request is not found; wherein the first action comprises: using the first FM for inference to obtain the FM output for the first request; and wherein the second action comprises: using the first FM for inference to obtain a first output for the first request, using a second FM for inference to obtain a second output as the FM output for the first request, the second FM having a greater model size and/or capability than the first FM, and storing the first request in the first storage as suitable for processing by the first FM if the first output is similar to the second output.

In some embodiments, the first request is represented as an embedding vector when stored in the first storage.

In some embodiments, said using the first FM for inference to obtain the FM output for the first request comprises: if a first guide associated with the second request is found in a second storage, using the first FM with the first guide for inference to obtain the FM output for the first request; and if no guide associated with the second request is found in the second storage, using the first FM without any guide for inference to obtain the FM output for the first request.

In some embodiments, the first and storages are a same storage.

In some embodiments, the first and storages are different storages.

In some embodiments, said using the first FM for inference to obtain the first output for the first request and said storing the first request in the first storage as suitable for processing by the first FM comprise: using the first FM without any guide for inference to obtain a third output for the first request; if the third output is similar to the second output, storing the first request in the first storage as suitable for processing by the first FM; and if the third output is not similar to the second output, performing the following steps: obtaining a second guide for the first request, using the first FM with the second guide for inference to obtain a fourth output for the first request, and if the fourth output is similar to the second output, storing the first request in the first storage as suitable for processing by the first FM, and storing the second guide in the second storage.

In some embodiments, the second guide is a form of plain text when stored in the second storage.

In some embodiments, said obtaining the second guide for the first request comprises: obtaining the second guide from the second storage for the first request; or obtaining the second guide using a third FM for the first request, the third FM having a greater model size and/or capability than the first FM.

In some embodiments, the second and third FMs are a same FM.

In some embodiments, the second and third FMs are different FMs.

In some embodiments, the computerized method further comprises: if the fourth output is not similar to the second output, storing the first request in the first storage as suitable for processing by the second FM.

In some embodiments, the computerized method further comprises: using the second FM for inference to obtain the FM output for the first request if the second request is found and is suitable for processing by the second FM.

In some embodiments, the computerized method further comprises: prior to said searching for the second request similar to the first request, obtaining a routing decision for the first request; wherein the routing decision is to use the second FM to obtain the FM output for the first request.

In some embodiments, said obtaining the routing decision for the first request comprises: obtaining the routing decision for the first request using a static router.

In some embodiments, the static router is a predictive type router.

In some embodiments, the static router is a non-predictive type router.

In some embodiments, said similar refers to semantically similar.

In some embodiments, said similar refers to a similarity greater than a threshold.

In some embodiments, said similar is determined by a similarity comparison using a vector similarity method or a large-language-model (LLM) as a judge method.

According to one aspect of this disclosure, there is provided a system comprising: one or more non-transitory, computer-readable storage media; and one or more processors functionally connected to the one or more non-transitory, computer-readable storage media; wherein the one or more non-transitory, computer-readable storage media comprising computer-executable instructions; and wherein the instructions, when executed, cause the one or more processors to perform any of the above-described methods and/or any of the methods disclosed herein.

According to one aspect of this disclosure, there is provided an apparatus comprising one or more processors functionally connected to one or more memories storing instructions; the one or more processors are configured to execute the instructions to perform any of the above-described methods and/or any of the methods disclosed herein.

According to one aspect of this disclosure, there is provided one or more memories storing instructions; the instructions, when executed, cause one or more processors to perform any of the above-described methods and/or any of the methods disclosed herein.

In another aspect, embodiments of this disclosure provide an apparatus, wherein the apparatus comprises a function or unit to perform any of the above-described methods and/or any of the methods disclosed herein.

In another aspect, embodiments of this disclosure provide a computer readable storage medium, comprising one or more instructions, wherein when the one or more instructions are run on a computer, the computer performs any of the above-described methods and/or any of the methods disclosed herein.

In another aspect, embodiments of this disclosure provide a non-transitory computer-readable medium storing instruction the instructions causing a processor in a device to implement any of the above-described methods and/or any of the methods disclosed herein.

In another aspect, embodiments of this disclosure provide a device configured to perform any of the above-described methods and/or any of the methods disclosed herein.

In another aspect, embodiments of this disclosure provide a processor, configured to execute instructions to cause a device to perform any of the above-described methods and/or any of the methods disclosed herein.

In another aspect, embodiments of this disclosure provide an integrated circuit configure to perform any of the above-described methods and/or any of the methods disclosed herein.

According to one aspect of this disclosure, there is provided a module comprising: one or more circuits for performing any of the above-described methods and/or any of the methods disclosed herein.

According to one aspect of this disclosure, there is provided one or more processors functionally connected to one or more memories for performing any of the above-described methods and/or any of the methods disclosed herein.

According to one aspect of this disclosure, there is provided an apparatus comprising: one or more processors functionally connected to one or more memories for performing any of the above-described methods and/or any of the methods disclosed herein.

According to one aspect of this disclosure, there is provided an apparatus configured to perform any of the above-described methods and/or any of the methods disclosed herein.

In some embodiments the apparatus comprises one or more units configured to perform any of the above-described methods and/or any of the methods disclosed herein.

According to one aspect of this disclosure, there is provided one or more non-transitory, computer-readable storage media comprising computer-executable instructions, wherein the instructions, when executed, cause at least one processing unit, at least one processor, or at least one circuits to perform any of the above-described methods and/or any of the methods disclosed herein.

According to one aspect of this disclosure, there is provided one or more computer-readable storage media storing a computer program, wherein, when the computer program is executed by an apparatus, the apparatus is enabled to implement any of the above-described methods and/or any of the methods disclosed herein.

According to one aspect of this disclosure, there is provided a computer program product including one or more instructions, wherein, when the instructions are executed by an apparatus, the apparatus is enabled to implement any of the above-described methods and/or any of the methods disclosed herein.

According to one aspect of this disclosure, there is provided a computer program, wherein, when the computer program is executed by a computer, an apparatus is enabled to implement any of the above-described methods and/or any of the methods disclosed herein.

According to one aspect of this disclosure, there is provided a system comprising a node for performing any of the above-described methods and/or any of the methods disclosed herein.

According to one aspect of this disclosure, there is provided an apparatus for implementing any of the above-described methods and/or any of the methods disclosed herein in any possible implementation of the foregoing aspects.

In various embodiments, the above-described methods and/or the methods disclosed herein (denoted “disclosed methods”) provide various benefits.

For example, the disclosed methods implement in-context, continual learning to route incoming user requests to the appropriate FM (being either the weaker (but cheaper) FM or the stronger (but more expensive) FM) in a layered architecture. Thanks to the in-context, continual learning, the disclosed methods substantially reduce the cost (for example, to more than 50.2%) of using the stronger FM of the layered architecture while maintaining most (such as more than 90.5%) of the response quality of the stronger FM.

The disclosed methods implement in-context, continual learning to improve the capabilities of a weaker FM in a layered architecture, through generating guides with the help of a stronger FM and storing them in a memory database. Thanks to in-context, continual learning, the generated guides demonstrate high degree of intra-domain generalization, leading to a better quality of responses compared to prior-art methods using a standalone weaker FM.

The disclosed methods implement in-context, continual learning to route incoming user requests to the appropriate FM in a layered architecture. Thanks to in-context, continual learning, the disclosed methods may use a dynamic, real-time router, in contrast to the routers in prior art which all are post-deployment. As such, the disclosed methods do not rely on the specific FMs in the layered architecture, their consequent updates and changes, their updates and changes in training datasets, and/or the like.

The disclosed methods implement in-context, continual learning to improve the capabilities of the weaker FM in a layered architecture. Thanks to in-context, continual learning, the disclosed methods have the added benefit of caching generated guides on the edge devices, in an edge-cloud layered architecture, thereby reducing the need for repeated expensive inference on the cloud.

The disclosed methods implement in-context, continual learning to improve the capabilities of the weaker FM in a layered architecture through generated guides. Thanks to in-context, continual learning, the disclosed methods implement personalize the edge-cloud layered architecture to the user's needs and expectations, and substantially improve user experience.

### BRIEF DESCRIPTION OF THE DRAWINGS

For a more complete understanding of the disclosure, reference is made to the following description and accompanying drawings, in which:

FIG. 1 is a schematic diagram of a computer network system, according to some embodiments of this disclosure;

FIG. 2 is a schematic diagram showing a simplified hardware structure of a computing device of the computer network system shown in FIG. 1;

FIG. 3 is a schematic diagram showing a simplified software architecture of a computing device of the computer network system shown in FIG. 1;

FIG. 4 is a schematic diagram showing an artificial intelligence (AI) engine, wherein the AI engine comprises a large language model (LLM);

FIGS. 5A to 5C are schematic diagrams showing different types of the LLMs shown in FIG. 4, wherein

FIG. 5A is a schematic diagram showing an encoder-based LLM,

FIG. 5B is a schematic diagram showing a decoder-based LLM, and

FIG. 5C is a schematic diagram showing an encoder-decoder-based LLM;

FIG. 6 is a chart showing using a Real-time Adapting Router (RAR) method to enhance the capabilities of a weaker foundation model (FM) with the assistance of a stronger FM while reducing the reliance on the stronger FM overtime, according to some embodiments of this disclosure;

FIG. 7 is a flowchart showing the steps of a Real-time Adapting Router (RAR) method for using a weaker FM and a stronger FM to generate an FM output for an input prompt according to some embodiments of this disclosure;

FIG. 8 is a schematic diagram showing an example of the RAR method shown in FIG. 7, according to some embodiments of this disclosure;

FIG. 9 is a schematic diagram showing another example of the RAR method shown in FIG. 7, according to some other embodiments of this disclosure; and

FIG. 10 is a schematic diagram showing yet another example of the RAR method shown in FIG. 7, according to yet some other embodiments of this disclosure.

FIG. 11 is a schematic diagram showing yet another example of the RAR method shown in FIG. 7, according to still some other embodiments of this disclosure.

### DETAILED DESCRIPTION

Embodiments disclosed herein relate to artificial intelligence (AI) judge systems employing search-driven constitution-based framework, and apparatuses, methods, and non-transitory computer-readable storage media therefor. The systems and apparatuses disclosed herein may comprise suitable modules and/or circuitries for executing various procedures.

As those skilled in the art understand, a “module” is a term of explanation referring to a hardware structure such as a circuitry implemented using technologies such as electrical and/or optical technologies (and with more specific examples of semiconductors) for performing defined operations or processing. A “module” may alternatively refer to the combination of a hardware structure and a software structure, wherein the hardware structure may be implemented using technologies such as electrical and/or optical technologies (and with more specific examples of semiconductors) in a general manner for performing defined operations or processing according to the software structure in the form of a set of instructions stored in one or more non-transitory, computer-readable storage devices or media.

As will be described in more detail below, a module may be a part of a device, an apparatus, a system, and/or the like, wherein the module may be coupled to or integrated with other parts of the device, apparatus, or system such that the combination thereof forms the device, apparatus, or system. Alternatively, the module may be implemented as a standalone device or apparatus.

The module usually executes a procedure for performing a method. Herein, a procedure has a general meaning equivalent to that of a method. More specifically, a procedure is a defined method implemented using hardware components for processing data. A procedure may comprise or use one or more functions for processing data as designed. Herein, a function is a defined sub-procedure or sub-method for computing, calculating, or otherwise processing input data in a defined manner and generating or otherwise producing output data.

As those skilled in the art will appreciate, a procedure may be implemented as one or more software and/or firmware programs having necessary computer-executable code or instructions and stored in one or more non-transitory computer-readable storage devices or media which may be any volatile and/or non-volatile, non-removable or removable storage devices such as RAM, ROM, EEPROM, solid-state memory devices, hard disks, CDs, DVDs, flash memory devices, and/or the like. A module may read the computer-executable code from the storage devices and execute the computer-executable code to perform the procedure.

Alternatively, a procedure may be implemented as one or more hardware structures having necessary electrical and/or optical components, circuits, logic gates, integrated circuit (IC) chips, and/or the like.

### A. System Structure

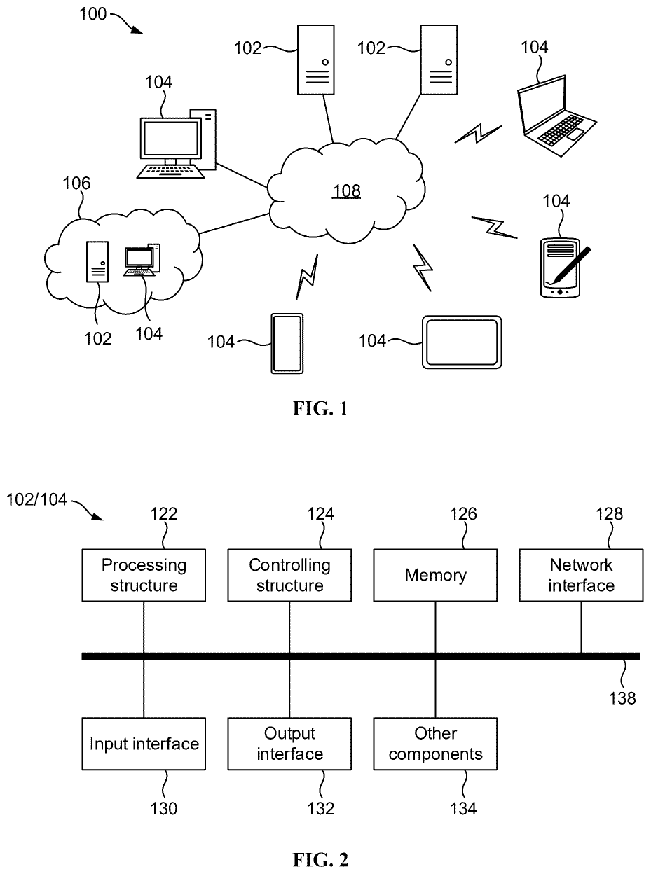

Turning now to FIG. 1, a computer network system is shown and is generally identified using reference numeral 100. As shown, the computer network system 100 comprises one or more server computers 102, a plurality of client computing devices 104, and one or more client computer systems 106 functionally interconnected by a network 108, such as the Internet, a local area network (LAN), a wide area network (WAN), a metropolitan area network (MAN), and/or the like, via suitable wired and wireless networking connections.

The server computers 102 may be computing devices designed specifically for use as a server, and/or general-purpose computing devices acting server computers while also being used by various users. Each server computer 102 may execute one or more server programs.

The client computing devices 104 may be portable and/or non-portable computing devices such as laptop computers, tablets, smartphones, Personal Digital Assistants (PDAs), desktop computers, and/or the like. Each client computing device 104 may execute one or more client application programs which sometimes may be called “apps”.

Generally, the computing devices 102 and 104 comprise similar hardware structures such as hardware structure shown in FIG. 2. As shown, the computing device 102/104 comprises a processing structure 122, a controlling structure 124, one or more non-transitory computer-readable memory or storage devices 126, a network interface 128, an input interface 130, and an output interface 132, functionally interconnected by a system bus 138. The computing device 102/104 may also comprise other components 134 coupled to the system bus 138.

The processing structure 122 may be one or more single-core or multiple-core computing processors, generally referred to as central processing units (CPUs), such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, NVIDIA processor, or the like. When the processing structure 122 comprises a plurality of processors, the processors thereof may collaborate via a specialized circuit such as a specialized bus or via the system bus 138.

The processing structure 122 may also comprise one or more real-time processors, programmable logic controllers (PLCs), microcontroller units (MCUs), u-controllers (UCs), specialized/customized processors, hardware accelerators, and/or controlling circuits (also denoted “controllers”) using, for example, field-programmable gate array (FPGA) or application-specific integrated circuit (ASIC) technologies, and/or the like. In some embodiments, the processing structure includes a CPU (otherwise referred to as a host processor) and a specialized hardware accelerator which includes circuitry configured to perform computations of neural networks such as tensor multiplication, matrix multiplication, and the like. The host processor may offload some computations to the hardware accelerator to perform computation operations of neural network. Examples of a hardware accelerator include a graphics processing unit (GPU), Neural Processing Unit (NPU), and Tensor Process Unit (TPU). In some embodiments, the host processors and the hardware accelerators (such as the GPUs, NPUs, and/or TPUs) may be generally considered processors.

Generally, the processing structure 122 comprises necessary circuitries implemented using technologies such as electrical and/or optical hardware components for executing one or more processes, as the design purpose and/or the use case maybe. For example, the processing structure 122 may comprise logic gates implemented by semiconductors to perform various computations, calculations, and/or processings. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processing thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation”, or more generally, “processing”, for generating or producing the outputs from the inputs thereof.

Sophisticated combinations of logic gates in the form of a circuitry of logic gates, such as the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed functions. In this example, the processes and functions thereof are “hard-coded” in the circuitry.

With the advance of technologies, it is often that a circuitry of logic gates such as the processing structure 122 may be alternatively designed in a general manner so that it may perform various processes and functions according to a set of “programmed” instructions implemented as firmware and/or software and stored in one or more non-transitory computer-readable storage devices or media. In this example, the circuitry of logic gates such as the processing structure 122 is usually of no use without meaningful firmware and/or software.

Of course, those skilled the art will appreciate that a process or a function (and thus the processor 102) may be implemented using other technologies such as analog technologies.

Referring back to FIG. 2, the controlling structure 124 comprises one or more controlling circuits, such as graphic controllers, input/output chipsets and the like, for coordinating operations of various hardware components and modules of the computing device 102/104.

The memory 126 comprises one or more storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like.

The network interface 128 comprises one or more network modules for connecting to other computing devices or networks through the network 108 by using suitable wired or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, fifth-generation New Radio (5G NR) and/or other 5G networks, fifth-generation (6G) networks, and/or the like. In some embodiments, parallel ports, serial ports, USB connections, optical connections, or the like may also be used for connecting other computing devices or networks although they are usually considered as input/output interfaces for connecting input/output devices.

The input interface 130 comprises one or more input modules for one or more users to input data via, for example, touch-sensitive screen, touch-sensitive whiteboard, touch-pad, keyboards, computer mouse, trackball, microphone, scanners, cameras, and/or the like. The input interface 130 may be a physically integrated part of the computing device 102/104 (for example, the touch-pad of a laptop computer or the touch-sensitive screen of a tablet), or may be a device physically separate from, but functionally coupled to, other components of the computing device 102/104 (for example, a computer mouse). The input interface 130, in some implementation, may be integrated with a display output to form a touch-sensitive screen or touch-sensitive whiteboard.

The output interface 132 comprises one or more output modules for output data to a user. Examples of the output modules comprise displays (such as monitors, LCD displays, LED displays, projectors, and the like), speakers, printers, virtual reality (VR) headsets, augmented reality (AR) goggles, and/or the like. The output interface 132 may be a physically integrated part of the computing device 102/104 (for example, the display of a laptop computer or tablet), or may be a device physically separate from but functionally coupled to other components of the computing device 102/104 (for example, the monitor of a desktop computer).

The computing device 102/104 may also comprise other components 134 such as one or more positioning modules, temperature sensors, barometers, inertial measurement unit (IMU), and/or the like.

The system bus 138 interconnects various components 122 to 134 enabling them to transmit and receive data and control signals to and from each other.

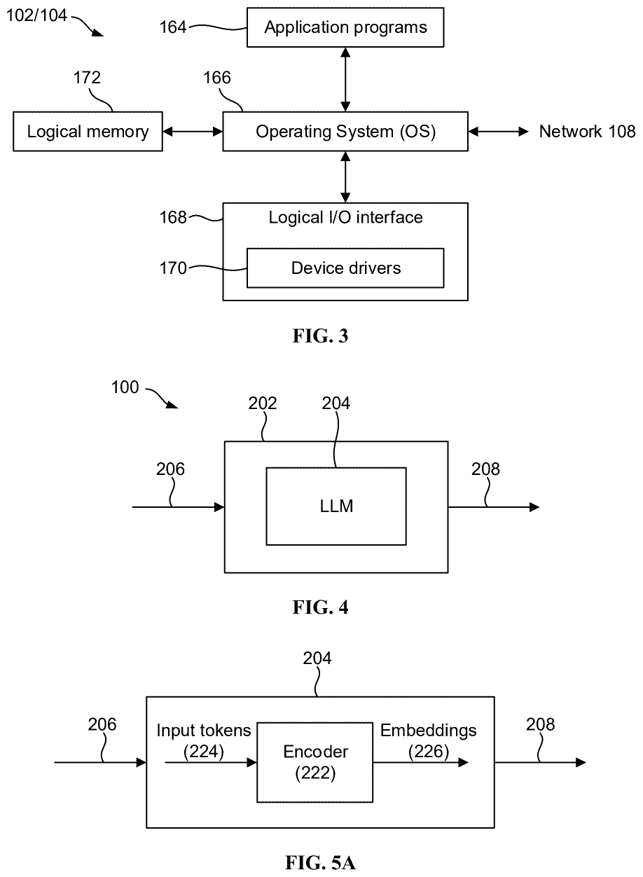

FIG. 3 shows a simplified software architecture of the computing device 102 or 104. On the software side, the computing device 102 or 104 comprises one or more application programs 164, an operating system 166, a logical input/output (I/O) interface 168, and a logical memory 172. The one or more application programs 164, operating system 166, and logical I/O interface 168 are generally implemented as computer-executable instructions or code in the form of software programs or firmware programs stored in the logical memory 172 which may be executed by the processing structure 122.

The one or more application programs 164 executed by or run by the processing structure 122 for performing various tasks.

The operating system 166 manages various hardware components of the computing device 102 or 104 via the logical I/O interface 168, manages the logical memory 172, and manages and supports the application programs 164. The operating system 166 is also in communication with other computing devices (not shown) via the network 108 to allow application programs 164 to communicate with those running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Linux, ANDROID® (ANDROID is a registered trademark of Google LLC, Mountain View, CA, USA), or the like. The computing devices 102 and 104 may all have the same operating system, or may have different operating systems.

The logical I/O interface 168 comprises one or more device drivers 170 for communicating with respective input and output interfaces 130 and 132 for receiving data therefrom and sending data thereto. Received data may be sent to the one or more application programs 164 for being processed by one or more application programs 164. Data generated by the application programs 164 may be sent to the logical I/O interface 168 for outputting to various output devices (via the output interface 132).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and the like, generally for long-term data storage therein. The logical memory 172 also comprises a working memory area that is generally mapped to high-speed, and in some implementations volatile, physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

In a server computer 102, the one or more application programs 164 generally provide server functions for managing network communication with client computing devices 104 and facilitating collaboration between the server computer 102 and the client computing devices 104. Herein, the term “server” may refer to a server computer 102 from a hardware point of view or a logical server from a software point of view, depending on the context.

As described above, the processing structure 122 is usually of no use without meaningful firmware and/or software. Similarly, while a computer system such as the computer network system 100 may have the potential to perform various tasks, it cannot perform any tasks and is of no use without meaningful firmware and/or software. As will be described in more detail later, the computer network system 100 described herein and the modules, circuitries, and components thereof, as a combination of hardware and software, generally produces tangible results tied to the physical world, wherein the tangible results such as those described herein may lead to improvements to the computer devices and systems themselves, the modules, circuitries, and components thereof, and/or the like.

B. Layered Foundation Models with Real-Time Adapting Routing

In some embodiments, the computer network system 100 executes an artificial intelligence (AI) engine (for example, in the form of one or more software programs). As shown in FIG. 4, the AI engine 202 comprises a foundation model (FM) such as a LLM 204 (which is used as an example in the following description), for processing input 206 (also called “prompt”; for example, natural language input in the form of text, voice, images, and/or the like), recognizing and interpreting the input 206 for generating the output 208 in suitable forms (for example, in form of text, image, audio, video, and/or the like) as the response to the prompt 206. As those skilled in the art will appreciate, foundation models such as LLMs are neural network models that learn the semantics and syntax of language by encoding (sub) words into vector representations.

Using LLMs as an example, LLMs use transformer models and are trained using massive datasets. Current LLMs such as Chat-GPT, GPT-4, LLAMA, and PaLM2 have proven to achieve state-of-the-art (SOTA) performance in various natural language processing (NLP) tasks.

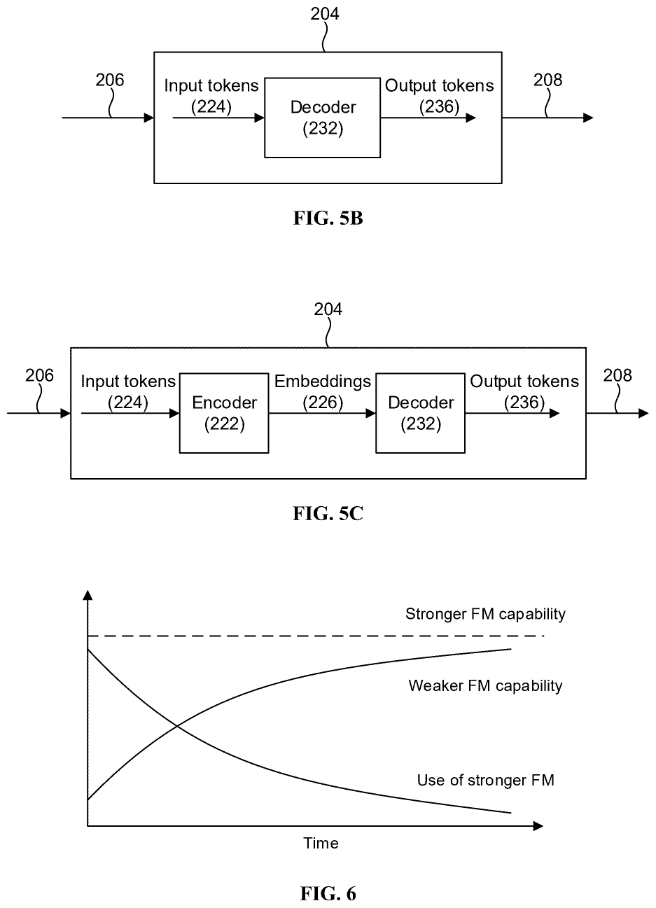

FIGS. 5A to 5C are schematic diagrams showing different types of LLM 204. These figures are simplified diagrams for showing the different types of LLM 204 only, and those skilled in the art will understand that the LLM 204 may also comprise other functional modules that are not shown in these figures.

FIG. 5A shows an encoder-based LLM 204 comprising an encoder 222 which processes the input tokens 224 (which are the units (for example, words or characters partitioned from the prompt 206) and generates embeddings 226 (which are then used to generate the output 208). As those skilled in the art understand, embeddings are high-dimensional vectors encoding semantic contexts and relationships of data tokens.

Most popular LLMs 204 are decoder-based (or “decoder-only”) models. As shown in FIG. 5B, the LLM 204 may be a LLM comprising a decoder 232 which processes the input tokens 224 and generates output tokens 236 (which are then used to generate the output 208). More specifically, the decoder-only LLM 204 learns to produce a distribution for the next token in a sequence given past context as input.

As shown in FIG. 5C, the LLM 204 may be an encoder-decoder-based LLM comprising an encoder 222 which processes the input tokens 224 and generates embeddings 226, and a decoder 232 which generates output tokens 236 based on the embeddings 226 (which are then used to generate the output 208).

LLMs have significantly improved the state-of-the-art on various NLP tasks. These models, powered by advanced techniques such as the generative pre-trained transformer (GPT) architecture, can learn the distribution of their training set well enough to generate realistic text.

As described above, a layered FM architecture that combines larger (or stronger) and smaller (or weaker) FMs has been used for addressing the dilemma between maximizing language model capabilities and minimizing the computer resources and costs.

The effectiveness of such a layered architecture depends on the performance of the model routing method. A number of solutions for model routing have been proposed in the literature, which can be broadly categorized into using machine learning based routers to predict model selection, and cascading model inferences until an acceptable response is returned.

Model routing can be applied to both cloud-based and edge-based FMware. Cloud-based chat applications such as OpenAI's ChatGPT and Anthropic's Claude can benefit from routing methods by sending simpler requests to less compute-intensive versions of their underlying FMs, and more complex requests to larger models, all without sacrificing the quality of response. Edge-based FMware often utilizes cloud-edge collaboration, wherein simpler requests may be sent to an edge-hosted FM, meanwhile complex ones are forwarded to a cloud-hosted FM instead. This setup allows to reduce compute costs by offloading some of the computation to the hardware on the edge device, while also preserving the privacy of users as a portion of the data never leaves the device.

Model routing and layering is a model routing method aims to balance the quality of FM-generated output and the associated inference costs by selecting the most optimal model for a given request. Model routing and layering methods may be partitioned into two major categories of routing methods, including non-predictive routing methods and predictive routing methods.

Non-predictive routing methods are based on collecting FM-generated outputs, typically done sequentially, until an answer passes some quality threshold.

Predictive routing methods use the contents of the input request to predict the optimal model selection, bypassing the need for model output and thus leading to reduced costs and latency compared to the non-predictive routing approach. Predictive routing can be implemented by training machine learning models on supervised classification or ranking tasks using a dataset of input requests and associated model preference labels. As an example, RouteLLM uses a prompt-model human preference dataset to train several ranking and classification models to predict the optimal model selection.

However, these methods have their own set of limitations.

For example, one of the limiting factors in non-predictive routing methods is an increased cost due to many rounds of model inference to acquire a satisfactory response.

On the other hand, the performance of predictive routing methods is often limited by the quality of the training dataset and how well it can represent the real-world distribution of user-inputs. For example, a router trained only on a human preference dataset demonstrates similar performance to a random baseline when evaluated on two different problem-solving benchmarks, highlighting the impact of careful training data selection on performance. Additionally, the capabilities of many model-based routers are static post-deployment and require re-training and re-deployment whenever the training dataset or FM capabilities are updated.

Thus, the prior-art model routing methods are limited by a set of shortcomings including redundant inference and latency costs (for non-predictive routing), reliance on training dataset generalization, and complexity of adaptation to new data (for predictive routing).

In the following, various embodiments of Real-time Adapting Router (RAR) methods are disclosed. The RAR methods adapt to the evolution of FM capabilities and improve model routing decisions overtime to address at least some of the above-descried limitations in prior art, and/or to decrease overall computation costs while maintaining the quality of responses.

As shown in FIG. 6, the RAR methods disclosed herein address at least some of the above-described limitations by improving upon static model-based routing methods (for example, those in RouteLLM) through enhancing the weaker FM capabilities with Continual Learning (CL) from the stronger FM as the system is in use, and dynamically adjusting routing decisions to increase utilization of the weaker FM and decreasing overall inference costs. In various embodiments, the RAR methods disclosed herein use step-by-step reasoning from the stronger FM as an in-context instruction guide (also denoted “guide” for simplicity) to assist the smaller and less capable FM to successfully complete given tasks.

Herein, between a weaker FM and a stronger FM, the weaker FM has a smaller model size (such as less number of model parameters) compared to the stronger FM. For example, a weaker FM may have three (3) billion model parameters, but a stronger FM may have 405 billion model parameters.

Alternatively or in addition, a weaker FM may have a smaller reasoning capability (such as lower performance (for example, measured by task-specific benchmarks) in some selected group of tasks (such as summarization, question and answering, coding, reasoning and planning, and/or the like), compared to a stronger FM.

Herein, a guide is a set of natural language, ordered or unordered instructions that can be used to reason about and solve a given problem (for which the guide was created). The relationship between a guide and a solution is similar to a cooking recipe and a specific dish. The guide (recipe) does not contain the solution (dish). Rather, the guide (recipe) contains the instructions to obtain the solution (dish).

For the cloud-edge collaboration use case, the RAR methods disclosed herein also provide the benefit of caching generated guides on the edge device, reducing the need for repeated inference on the expensive stronger FM. Additionally, depending on the use habits of the user, the weaker FM hosted on the edge also becomes more personalized to the user's needs as the system acquires more guides from the user's requests. The enhanced personalization leads to improved user experience as the system can better match user's expectations.

As will be described in more details below, in a layered architecture with a first FM (such as a stronger FM) and a second FM (such as a weaker FM), the RAR methods overtime maintain as closely as possible the overall capability levels of the stronger FM, and reduce the use of strong FM by maximizing the usage and capabilities of the weaker FM (see FIG. 6). This is achieved by the weaker FM utilizing the guides generated by stronger FM, as part of its context to assist in generating a response.

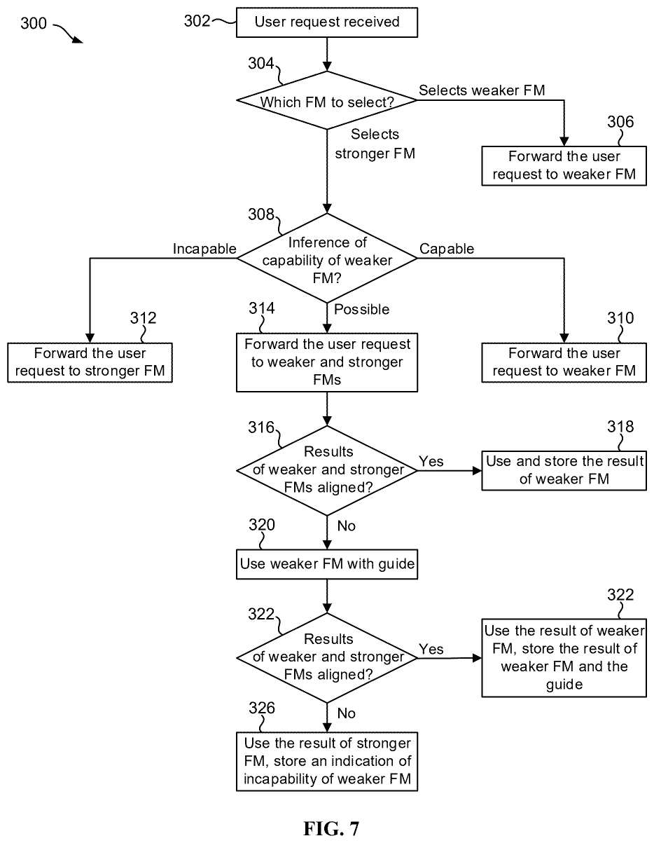

FIG. 7 is a flowchart showing the steps of a RAR method 300 according to some embodiments of this disclosure.

As shown, when a user request is received (step 302), the received user request is first given to a static router for making a routing decision (step 304), that is, deciding whether the user request is forwarded to a first, stronger FM or a second, weaker FM. For ease of description, in the following, the term “stronger FM” refers to the first, stronger FM, and the term “weaker FM” refers to the second, weaker FM, unless otherwise explicitly noted (for example, a “third, stronger FM” described below).

In some embodiments, the static router is a model-based predictive router that has been pre-trained to select the optimal FM given an input/user query (for example, the routers presented in RouteLLM). In these embodiments, the static router is used to obtain an initial routing decision, so as to avoid the need of costly and unnecessary FM inference operations to obtain the initial routing decision.

In the case that the weaker FM (for example, the on-device FM) is selected (the “Selects weaker FM” branch of step 304), the RAR method 300 forwards the request directly to the weaker FM (step 306) since the goal of the RAR method 300 is to use the least compute-intensive model.

In the case that the routing decision selects the stronger FM (the “Selects stronger FM” branch of step 304), the RAR method 300 performs an inference (denoted as “shadow inference”) to evaluate whether the weaker FM may still successfully serve the given user request (step 308), either by the weaker FM itself or with a guide (such as a stored guide previously generated by a third, stronger FM (which may or may not be the first, stronger FM depending on the implementation)). As the third, stronger FM may provide insightful and knowledgeable information in the generated guide, the weaker FM may use the guide provided by the third, stronger FM through in-context learning to improve the quality of the generated response.

If, at step 308, the shadow inference determines that the weaker FM can serve the given user request (the “Capable” branch of step 308, that is, being capable of performing appropriate reasoning of the given user request), the user request is then sent to the weaker FM (step 310).

In some embodiments, the shadow inference at this step may determine that the weaker FM is capable of performing appropriate reasoning of the given user request without any guide (and accordingly the user request is forwarded to the weaker FM at step 310 without any guide) or with a guide (and accordingly the user request is forwarded to the weaker FM at step 310 with the guide).

If, at step 308, the shadow inference determines that the weaker FM cannot serve the given user request (the “Incapable” branch of step 308), the user request is then sent to the stronger FM (step 312).

If, at step 308, the shadow inference determines that the weaker FM is possibly capable of performing appropriate reasoning of the given user request (the “Possible” branch of step 308), the user request is then sent to the stronger FM and the weaker FM (step 314).

Then, the reasoning results of the stronger FM and the weaker FM are compared (step 316). If the reasoning results thereof are aligned with each other (that is, same or matching with each other) (the “Yes” branch of step 316), the result of the weaker FM is used (such as sent to the user, further processed, and/or the like), and the user request and the result are stored for use by the shadow inference in the future (step 318).

If, at step 316, the reasoning results of the stronger FM and the weaker FM are not aligned with each other (that is, different or mismatching with each other) (the “No” branch of step 316), the weaker FM is used again with a suitable guide (such as a stored guide or a guide generated by a fourth, stronger FM (which may or may not be the first, stronger FM or the third, stronger FM, depending on the implementation)) for reasoning the user request (step 320).

At step 322, the reasoning result of the weaker FM obtained at step 320 using the guide is compared with the result of the stronger FM (obtained at step 314). If the results thereof are aligned with each other (the “Yes” branch of step 322), the result of the weaker FM is used (such as sent to the user, further processed, and/or the like), and the user request, the result, and the corresponding guide that the weaker FM is used to obtain this result are stored for use by the shadow inference in the future (step 324).

If, at step 322, the reasoning result of the weaker FM obtained at step 320 using the guide is not aligned with the reasoning result of the stronger FM (the “No” branch of step 322), the reasoning result of the stronger FM is used (such as sent to the user, further processed, and/or the like), and the request and an indication of using the stronger FM are stored for use by the shadow inference in the future (step 326).

Some details of the RAR method 300 are now described.

In some embodiments, a skill and guide storage such as a skill and guide memory, a skill and guide database (DB), and/or the like may be used for storing the user request, the reasoning result (of the weaker FM and/or the stronger FM), the indication of using the stronger FM, and the guide described in steps 318, 322, and 326. In some embodiments, the user request, the reasoning result (of the weaker FM and/or the stronger FM), and the indication of using the stronger FM may be stored in a skill memory or DB, and the guide may be stored in a separate, guide memory or DB.

For example, when the weaker FM generates an aligned response (for example, a response contextually and semantically similar to that of the stronger FM) at step 314 or 320 (determined at the “Yes” branch of step 316 or 322, respectively), the request and the guide (if used) are recorded into a skill and guide memory. Future incoming requests are then compared against the ones stored in the skill and guide memory to determine whether the new request shall be sent to the weaker FM and whether the weaker FM requires a guide. Therefore, the RAR method 300 may accumulate a significant collection of useful guides overtime for that weaker FM to use in order to successfully serve similar requests. Accordingly, the system may route more samples to the weaker FM rather than the stronger FM as opposed to the conventional static router.

In some embodiments, the performance of the RAR method 300 is evaluated.

However, as those skilled in the art understand, in a real-world deployment, there may be little or even no guarantees to the domain constraints of the requests. Accordingly, automatically determining the validity of the generated response (without external input from an expert rater such as a user who knows what the response should be) is a very difficult task.

Therefore, in some embodiments where the FM operates in an open-domain environment, the performance evaluation of the RAR method 300 is not to evaluate the correctness of the system to the unavailable ground truth. Rather, the performance of the RAR method 300 is evaluated by comparing how well the RAR method 300 can maintain its performance close to that of the stronger FM (note that the output of the RAR method 300 can only be as good as the stronger FM's outputs as it only attempts to mimic the stronger FM's capabilities rather than surpass them).

For example, in some embodiments, the RAR method 300 uses the shadow inference to evaluate whether a user request (denoted “current user request”) is similar to a previous user request to determine whether the weaker FM is capable of processing the user request (at step 308).

For example, if the current user request is similar to a previous user request processed by the weaker FM, then, the weaker FM is capable of processing the current user request (the “Capable” branch of step 308). If the current user request is similar to a previous user request processed by the stronger FM, then, the weaker FM is incapable of processing the current user request (the “Incapable” branch of step 308). If no previous user request is found to be similar to the current user request, the weaker FM is possibly capable of processing the current user request (the “Possible” branch of step 308).

In some embodiments, the RAR method 300 also uses the shadow inference to evaluate whether the reasoning results of the weaker and stronger FMs are similar or aligned at steps 306 and 322.

Evaluating similarities of two requests or responses is not a trivial task.

In some embodiments, a semantic requests/responses comparison method is used. In these embodiments, to measure the similarity of two requests or two responses (for example, the weaker FM's response and stronger FM's response), the semantic requests/responses comparison method uses vector similarity metrics (for example, cosine or dot product of the metrics of the two requests or the two responses), or the LLM-as-a-judge method disclosed in the academic paper entitled “Judging LLM-as-a-judge with MT-bench and Chatbot Arena,” by Lianmin Zheng et al., in Proceedings of the 37th International Conference on Neural Information Processing Systems. NIPS 23. New Orleans, LA, USA: Curran Associates Inc., 2024. Of course, in some embodiments, other suitable requests/responses comparison methods may be alternatively or additionally used.

With the vector similarity method, a user may select a similarity score threshold that delineates whether or not two requests or two responses are considered similar (for example, a similarity score of the two requests or two responses higher than the similarity score threshold means that the two requests or two responses are similar). For the LLM-as-a-judge method, one may use a fifth FM (denoted a “comparison FM”, which may or may not be the first, second, third, or fourth FM described above depending on the implementation) to compare two requests or two responses and return a single-word answer whether the requests or responses are semantically similar or different. Regardless of the method used, the semantic requests/responses comparison method in some embodiments may generate a binary decision that is used to control the RAR method 300.

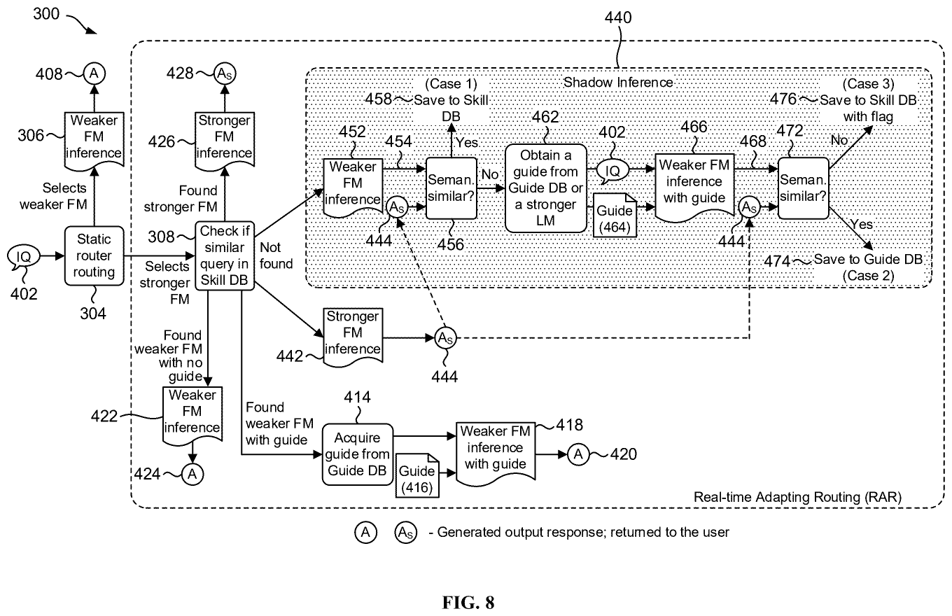

FIG. 8 is a schematic diagram showing an example of the RAR method 300 shown in FIG. 7. As shown, the RAR method 300 may initially use one or more static models to select a model (from the stronger FM and the weaker FM) based on the current input request 402 (denoted “IQ” in FIG. 8) (step 304), to avoid unnecessary model inference. At this step, any suitable static-model-based routing methods (such as any of the routing methods in RouteLLM) may be used.

If the initial static-model-based routing method selects the weaker FM for processing the request 402 (the “Selects weaker FM” branch of step 304), the RAR method 300 follows the decision and forwards the current request 402 to the weaker FM (step 306) for obtaining a FM output 408.

However, if, at step 304, the initial static-model-based routing method selects the stronger FM for processing the current request 402 (the “Selects stronger FM” branch of step 304), the RAR method 300 determines whether the current request 402 should be forwarded to the weaker FM for processing (for example, with or without a guide), or should be forwarded to the stronger FM for processing, in order to minimize expensive model inference calls from the stronger FM (step 308). In various embodiments, the determination at step 308 may be made by performing a shadow inference, or by using other suitable method (such as a conventional comparison method).

More specifically, at this step, the RAR method 300 searches in a skill memory such as a skill DB for a request previously processed by the weaker FM that is similar to the current request 402. If such a similar request is found in the skill DB (for example, if a similarity obtained through a comparison between the current request and a previous request in the skill DB is greater than a predefined or predetermined threshold), and if the record in the DB shows that the similar request was previously processed by the weaker FM with a guide (the “Found weaker FM with guide” branch of step 308), the RAR method 300 then finds the corresponding guide 416 from a guide memory (denoted a “guide DB”, which may be, for example, a separate DB or a part of the skill DB) (step 414), and sends the current request 402 and the guide 416 to the weaker FM (step 418) for obtaining a FM output 420.

If, at step 308, a similar request is found in the skill DB, and if the record in the skill DB shows that the similar request was previously processed by the weaker FM without a guide (the “Found weaker FM with no guide” branch of step 308), then, the RAR method 300 sends the current request 402 to the weaker FM without any guide (step 422) for obtaining a FM output 424.

If, at step 308, a similar request is found in the skill DB, and if the record in the skill DB shows that the similar request was previously processed by the stronger FM (the “Found stronger FM” branch of step 308), then, the RAR method 300 sends the current request 402 to the stronger FM (step 426) for obtaining a FM output 428.

If no similar request is found in the skill DB (the “Not Found” branch of step 308), then, the RAR method 300 performs a shadow inference 440 to maintain a good user experience.

As shown in FIG. 7, during the process of shadow inference 440, the current request 402 is first forwarded to the stronger FM (step 442) and the response 444 is then returned to the user.

The weaker FM is also used (step 452) to generate a response 454 from the current request. The responses 444 and 454 from the stronger FM and the weaker FM are then compared (step 456) for similarity therebetween, which leads to three cases described as follows.
Case 1: If the responses 444 and 454 from the stronger FM and the weaker FM are similar (for example, the semantic similarity therebetween is greater than a predefined or predetermined threshold), that is, the weaker FM generates an aligned response 454 to the current request 402 without any assistance (the “Yes” branch of step 456), the current request 402 is embedded into an embedding vector (which is a representation encoding the current request 402 and where similar items are close to each other) and is saved into the skill DB as a request associated with the weaker FM or a request suitable for processing by the weaker FM (step 458) which may be used in the future as a previous request. For example, when a future request comes in, it will be compared to the previous request in the skill DB as described above, for determining whether the future request should be forwarded to the weaker FM or the stronger FM as described above.
Cases 2 and 3: If the responses 444 and 454 from the stronger FM and the weaker FM are different (for example, the semantic similarity therebetween is smaller than a predefined or predetermined threshold), that is, the weaker FM is unable to generate an aligned response by itself (the “No” branch of step 456), then, the RAR method 300 searches for a guide in a guide memory such as the guide DB that corresponds to (or previously used by) a similar request (for example, a previous request with a semantic similarity greater than a threshold) (step 462). If such a guide 464 is found, the guide 464 is then used together with the current request 402 (in-context learning) to generate a response 468 using the weaker FM (step 466). If no guide is found, the RAR method 300 uses a stronger FM (that is, the third, stronger FM described above) to generate the guide 464 for the current request 402. The guide 464 is then used together with the current request 402 (in-context learning) to generate the response 468 using the weaker FM (step 466).

The responses 444 and 468 from the stronger FM and the weaker FM are then compared (step 472).
Case 2: If the responses 444 and 468 from the stronger FM and the weaker FM are aligned (for example, the response 468 generated by the weaker FM with the guide 464 is semantically similar to the stronger FM's response 444) (the “Yes” branch of step 472), it is considered that similar samples can also be successfully served by the weaker FM once a guide is provided. As such, the current request 402 is saved into the skill memory (such as the skill DB) as a request associated with the weaker FM or a request suitable for processing by the weaker FM, and the corresponding guide 464 is associated with the request 402 and saved into the guide memory (such as the guide DB) (step 474).
Case 3: If the responses 444 and 468 from the stronger FM and the weaker FM are not aligned (for example, the response 468 generated by the weaker FM with the guide 464 is semantically different to the stronger FM's response 444) (the “No” branch of step 472), the current request 402 is saved in the skill memory as a request associated with the stronger FM or a request suitable for processing by the stronger FM (for example, with a flag indicating that any future similar or identical requests shall be routed to the stronger FM) (step 476).

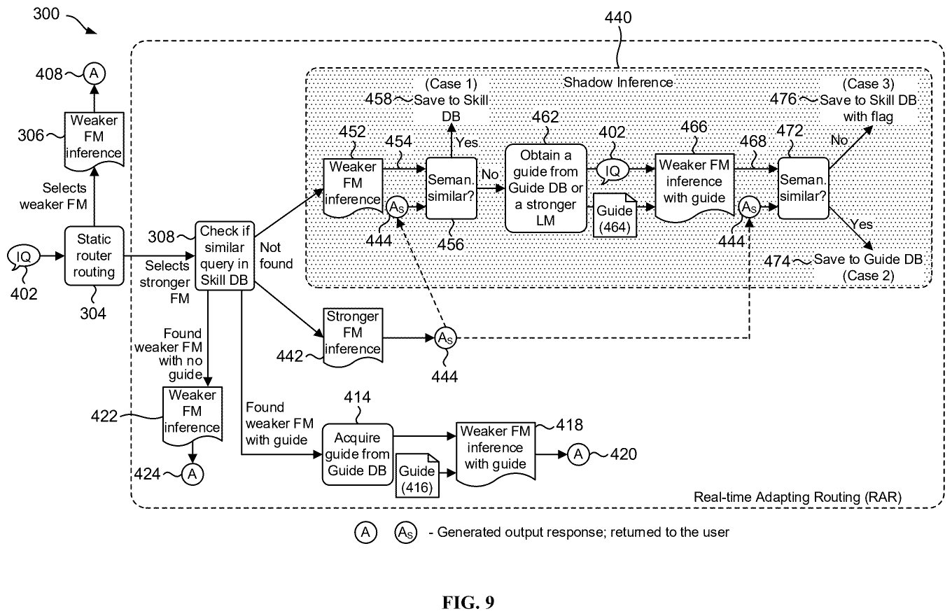

As shown in FIG. 9, in some embodiments, after a certain period of time (which may be a hyperparameter tuned over time), a similar request (that is, a request similar to a previous request saved under Case 3 for more than the certain period of time) may go through the shadow inference process 440 (instead of branching to step 426 from step 308) to assess whether any new guides (such as guides saved in the guide memory after that previous request was processed, or a new guide generated by the stronger FM during the shadow inference process 440) can now lead to an response of the weaker FM aligned with the response of the stronger FM.

In other words, the RAR method 300 in these embodiments may follow the process shown in FIG. 8 if request with an indication of the stronger FM is found in the skill DB for a certain period of time. After this certain period of time, the RAR method 300 follows the process shown in FIG. 9 if not request associated with the weaker FM is found in the skill DB.

In above embodiments, at step 462, the RAR method 300 first searches for a guide in the guide memory, and if no guide is found, uses a stronger FM to generate the guide 464 for the current request 402. In some embodiments, the RAR method 300 does not search for a guide in the guide memory. Rather, the RAR method 300 at step 462 simply uses the stronger FM to generate a guide for the weaker FM to use for processing the current request 402 at step 466. If the weaker FM generates an aligned response with the guide, the RAR method 300 moves to Case 2. If the weaker FM cannot use the guide to generate an aligned response, the RAR method 300 moves to Case 3 to save the current request in the skill memory with a flag indicating that any future similar or identical requests shall be routed to the stronger FM. After a certain period of time (which may be a hyperparameter tuned over time), a similar request may be repeated through the shadow inference process 440 to assess whether any new guide can now lead to an aligned response with the weaker FM.

Herein, guides are generated as instructions or hints that can assist in answering a given request but that do not contain the actual answer. In some embodiments, the guide memory may pre-fill or pre-store one or more guides when the system 100 is initially deployed. In some other embodiments, when the system 100 is initially deployed, the guide memory is empty and the majority of guides are generated by the stronger FM. Over time, the guide memory is populated as more guides are generated and evaluated, leading to new requests being able to reuse existing guides for response generation. The ability to re-use guides across different requests is the desired generalization behavior that differs RAR from simply memorizing solutions where each guide is only relevant to a unique request.

In some embodiments, skill and guide memories are represented as one or more vector databases that store the embedding vector of the request (embedding vectors are representations where similar items are close to each other) along with the corresponding guide in plain text. When an input request is received, indexing is done by comparison of the embedding vector of the input request and existing requests in the database, measured by any suitable similarity measurement such as the cosine similarity.

By varying the similarity threshold hyperparameter, the RAR method 300 may control the tradeoff between exploration (generate specific guides with stronger FM) and exploitation (use guides from less similar requests) in terms of acquiring a guide. This threshold ranges from zero to one, with a higher threshold meaning the requests must be more similar. Requests that do not require a guide for generating an aligned response are stored without attaching a guide therewith, compared to those that require a guide (which are attached with the corresponding guide), meaning that if the request is similar to an entry that does not contain a guide, this request is considered as Case 1 or Case 3, and can be forwarded directly to the corresponding FM (being the weaker FM in Case 1 or the stronger FM in Case 3) for inference.

Those skilled in the art will appreciate that, in various embodiments, the skill and guide memories may be implemented in any suitable ways without affecting the overall operation of the system 100.

As described above, in some embodiments, the first step of the RAR method 300 upon receiving an incoming request (that is, the current request 402) is to use a static router to obtain a routing decision, that is, whether to send the request to the weaker FM or start shadow inference. In various embodiments, the static router may be of any suitable type such as any predictive type or any non-predictive type, and may be any instance that has been designed or known in prior art, or any instance to be designed in future or in literature.

In some embodiments, semantic comparison is used, which may be carried out in either one or both of the following two situations:
(1) for comparing an incoming request with previous requests stored in the skill memory to decide whether the current capabilities of the weaker FM are sufficient for responding to the incoming request, and
(2) for comparing whether the response generate by the weaker FM is aligned and contextually similar to that of the stronger FM, so as to decide whether the weaker FM has acquired the capability to respond to the incoming request.

This semantic comparison may be performed by using a vector of any suitable similarity metrics including but not limited to cosine similarity and dot product. With the vector similarity method, any similarity threshold, which delineates whether or not two requests or two responses are considered similar, may be chosen.

As described above, when the static router selects the stronger FM for inference, the RAR method performs shadow inference. For this purpose, the weaker FM is used to generate a response to the incoming request, which may lead to one of the three distinct cases depending on the generated response:
(1) the response generated by the weaker FM is aligned with of that of the stronger FM;
(2) the two responses are different, where the RAR method then attempts to improve the weaker FM's response with a guide either generated by the stronger FM or extracted from the guide memory; and
(3) if the weaker FM with the guide does not generate an aligned response, the incoming request is saved in the skill memory with a flag indicating that any future similar request may be automatically routed to the stronger FM. After a certain period of time (which may be a tunable hyperparameter set to any value), any similar requests may repeat the shadow inference process 440 to assess whether any new guides that have been saved in the guide memory can now lead to an aligned response with the weaker FM.

In some embodiments, if any previous request in the Case 3 category is found at step 308 (the “Found stronger FM” branch thereof), the RAR method 300 always branches to step 426 (that is, the RAR method 300 would never repeat the shadow inference process 440 if any previous request in the Case 3 category is found at step 308).

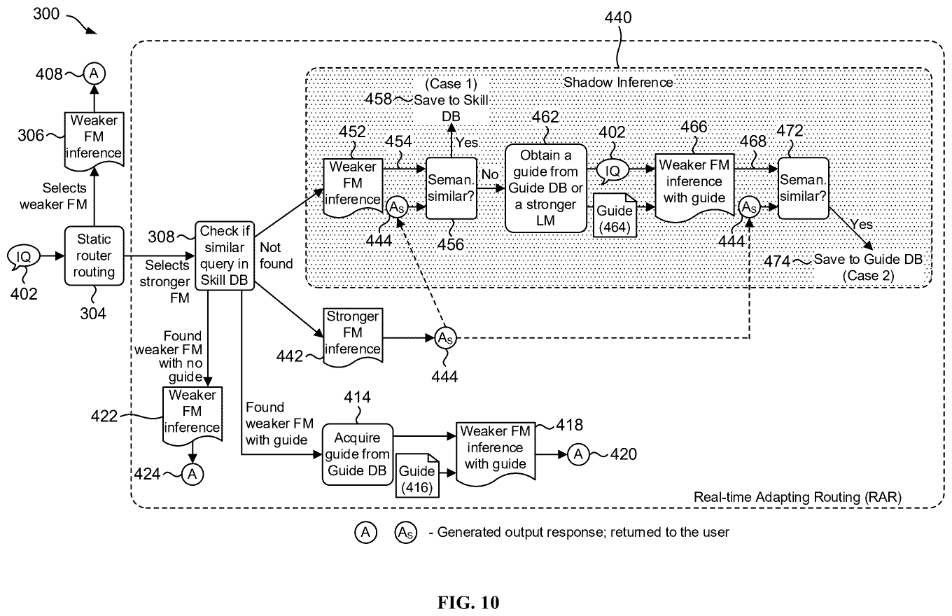

In some embodiments as shown in FIG. 10, the RAR method 300 does not store any indication for Case 3. Therefore, if no similar request of weaker FM is found in step 308, the shadow inference 440 is then used (that is, the RAR method 300 does not include step 426).

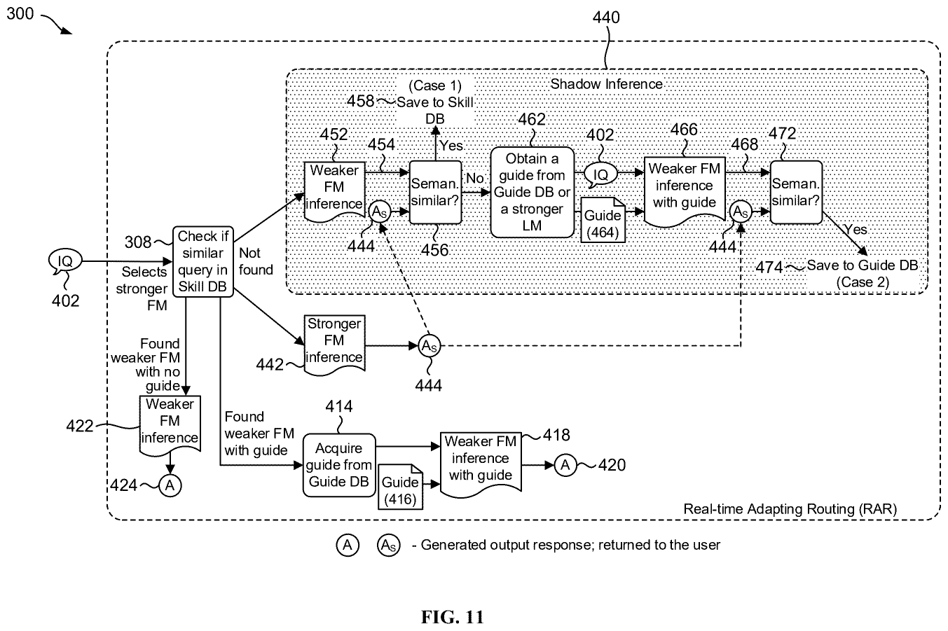

In some embodiments as shown in FIG. 11, the RAR method 300 may not use any static router (that is, not including steps 304 and 306).

In some embodiments, guides are generated as instructions or hints, in any shape or form (including but not limited to plain text, numerical embeddings or vectors, any visual format, and/or the like) that can assist the weaker FM in answering an incoming request, but that do not contain the actual answer.

In various embodiments, the skill and guide memories may be represented as any suitable types and forms of databases (including but not limited to vector databases), hosted on any suitable devices (such as on cloud or edge devices) at any suitable locations, for storing representations of any types and forms of the incoming requests and guides. The skill and guide memories may be implemented in any suitable ways and by any suitable means without affecting the overall operation of the system.

In various embodiments, the incoming requests, guides, and FM responses may be represented in any shapes and forms to be stored in the skill and guide memories or databases, and may be in any suitable forms when being presented to users. These shapes and forms include, but are not limited to, any types of numerical vectors and latent embeddings. These representations may be generated by any approach and by any possible means including but not limited to employing any legacy or advanced natural-language-processing embedding types, low or high dimensional, or using any type of FMs capable of embedding generation, to any extent, including but not limited to of those of OpenAI, all-Mini-L12-v2 model, with any output dimension.

In some embodiments, the RAR method may perform semantic comparison in two situations:
(1) to compare an incoming request with previous requests stored in the skill memory to decide whether the current capabilities of the weaker FM is sufficient for responding to the incoming request, and
(2) to compare the response generated by the weaker FM and that generated by the stronger FM to determine whether they are aligned and contextually similar, to decide whether the weaker FM has acquired the capability to respond to the incoming request.

In various embodiments, the semantic comparisons in any of both of the two situations may be done by employing any suitable types and any suitable instances of FMs, with any suitable parameter settings and mathematical weights, as a judge (such as but not limited to LLM-as-a-judge) or the like. With the FM-as-a-judge, any FM may be requested in any possible ways, including but not limited to question-answer with chatbots and sending requests to API endpoints, to compare two (or many) requests or two (or many) responses and return a decision in any suitable shape or format including but not limited to single-word answer or extended conversation with reasons, whether the requests or responses are semantically similar or different.

The RAR methods disclosed herein may be employed in any layered FM-based architecture, applied to any suitable use-case scenarios (such as open-ended conversations, code generation tasks, and/or the like) to dynamically and in real-time route the incoming user requests to the proper FM, such as the weaker FM (if the weaker FM is able to respond to the request in an standalone manner with our without the help of one or more guides) or the stronger FM (if the weaker FM cannot, by any means, generate an aligned response for the incoming request). A layered FM-based architecture may be implemented in any suitable approaches such as:
(1) Edge-Cloud Layered Architecture, wherein the weaker FM is hosted on the edge, while the stronger FM is hosted on the cloud as the fallback;
(2) All-Cloud Layered Architecture, wherein both the weaker and the stronger FMs are hosted on the cloud but at different endpoints;
(3) All-Edge Layered Architecture, wherein both the weaker and the stronger FMs are hosted on the edge devices but at different endpoints.

The AI system and methods disclosed herein provide several advantages.

For example, the AI system and methods disclosed herein implement in-context, continual learning to route incoming user requests to the appropriate FM (being either the weaker (but cheaper) FM or the stronger (but more expensive) FM) in a layered architecture. Thanks to the in-context, continual learning, the AI system and methods disclosed herein substantially reduce the cost (for example, to more than 50.2%) of using the stronger FM of the layered architecture while maintaining most (such as more than 90.5%) of the response quality of the stronger FM.

The AI system and methods disclosed herein implement in-context, continual learning to improve the capabilities of weaker FM in a layered architecture, through generating guides with the help of the stronger FM and storing them in a memory database. Thanks to in-context, continual learning, the generated guides demonstrate high degree of intra-domain generalization, leading to a better quality of responses compared to prior-art methods using a standalone weaker FM.

The AI system and methods disclosed herein implement in-context, continual learning to route incoming user requests to the appropriate FM in a layered architecture. Thanks to in-context, continual learning, the AI system and methods disclosed herein may use a dynamic, real-time router, in contrast to the routers in prior art which all are post-deployment. As such, the AI system and methods disclosed herein do not rely on the specific FMs in the layered architecture, their consequent updates and changes, their updates and changes in training datasets, and/or the like.

The AI system and methods disclosed herein implement in-context, continual learning to improve the capabilities of the weaker FM in a layered architecture. Thanks to in-context, continual learning, the AI system and methods disclosed herein have the added benefit of caching generated guides on the edge devices, in an edge-cloud layered architecture, thereby reducing the need for repeated expensive inference on the cloud.

The AI system and methods disclosed herein implement in-context, continual learning to improve the capabilities of the weaker FM in a layered architecture through generated guides. Thanks to in-context, continual learning, the AI system and methods disclosed herein implement personalize the edge-cloud layered architecture to the user's needs and expectations, and substantially improve user experience.

### C. Acronyms, Abbreviations, and Definition of Some Terms

| Full Name | Acronym/Abbreviation/Initialism |
|---|---|
| Foundation Model | FM |
| Large Language Model | LLM |
| FM-powered software | FMware |
| Real-time Adapting Routing | RAR |
| Chain-of-Thought | CoT |
| Continual Learning | CL |

Some technical terms are defined as follows:
Foundation Models (FMs): FMs such as large language models (LLMs) (for example, OpenAI's GPT) are mathematical models, with millions or billions of mathematical parameters, that are pre-trained on an enormous body of corpus, such as the information accessible through internet or cyclopedias, to acquire ground breaking abilities including understanding natural language. These models can be adapted to perform a wide range of specialized downstream tasks.
FM-powered software (FMware): FMware refers to software applications that employ one or various FMs as one of their building blocks.
Chain-of-Thought (CoT): CoT is a method that asks the FM to explicitly output its reasoning and has been shown to significantly improve the quality of the generated output, with the added benefit of providing the user with an explicit record of how the model arrived at this answer.
In-context learning: A method in which FMs respond to requests and perform tasks by learning from examples embodied within the input prompts, rather than adjusting their mathematical parameters.
Continual Learning (CL): CL, also referred to as lifelong learning, is an approach that aims to incrementally train models over a lifetime on a dynamic data distribution, compared to conventional methods that train models by learning a static distribution. CL method operates by changing the way the model learns, without updating the model's mathematical parameters.

Herein, the term “predefined” (for example, a “predefined” item such as a “predefined” parameter) refers to an item defined before the method disclosed herein is performed (for example, defined as a system design parameter such as defined by relevant standards).

Herein, the term “preconfigured” (for example, a “preconfigured” item such as a “preconfigured” parameter) refers to an item configured by a suitable apparatus before a certain even occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Although in above examples, the adaptive information retrieval method is performed by the computer network system 100, in some embodiments, no computer network system 100 is required, and the methods disclosed herein is performed by a single computing device 102 or 104.

In some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the above-described embodiments and/or features thereof may be customized, separated, and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A computerized method for obtaining a foundation model (FM) output for a first request, the method comprising:
searching, in a first storage, for a second request similar to the first request;
performing a first action if the second request is found and is suitable for processing by a first FM; and
performing a second action if the second request is not found;
wherein the first action comprises:
using the first FM for inference to obtain the FM output for the first request; and
wherein the second action comprises:
using the first FM for inference to obtain a first output for the first request,
using a second FM for inference to obtain a second output as the FM output for the first request, the second FM having a greater model size and/or capability than the first FM, and
storing the first request in the first storage as suitable for processing by the first FM if the first output is similar to the second output.

2. The computerized method of claim 1, wherein said using the first FM for inference to obtain the FM output for the first request comprises:
if a first guide associated with the second request is found in a second storage, using the first FM with the first guide for inference to obtain the FM output for the first request; and
if no guide associated with the second request is found in the second storage, using the first FM without any guide for inference to obtain the FM output for the first request.

3. The computerized method of claim 1, wherein said using the first FM for inference to obtain the first output for the first request and said storing the first request in the first storage as suitable for processing by the first FM comprise:
using the first FM without any guide for inference to obtain a third output for the first request;
if the third output is similar to the second output, storing the first request in the first storage as suitable for processing by the first FM; and
if the third output is not similar to the second output, performing the following steps:
obtaining a second guide for the first request,
using the first FM with the second guide for inference to obtain a fourth output for the first request, and
if the fourth output is similar to the second output, storing the first request in the first storage as suitable for processing by the first FM, and storing the second guide in the second storage.

4. The computerized method of claim 3, wherein said obtaining the second guide for the first request comprises:
obtaining the second guide from the second storage for the first request; or
obtaining the second guide using a third FM for the first request, the third FM having a greater model size and/or capability than the first FM.

5. The computerized method of claim 3 further comprising:
if the fourth output is not similar to the second output, storing the first request in the first storage as suitable for processing by the second FM.

6. A system comprising:
one or more non-transitory, computer-readable storage media; and
one or more processors functionally connected to the one or more non-transitory, computer-readable storage media;
wherein the one or more non-transitory, computer-readable storage media comprising computer-executable instructions; and
wherein the instructions, when executed, cause the one or more processors to perform the method of claim 1.

7. The system of claim 6, wherein said using the first FM for inference to obtain the FM output for the first request comprises:
if a first guide associated with the second request is found in a second storage, using the first FM with the first guide for inference to obtain the FM output for the first request; and
if no guide associated with the second request is found in the second storage, using the first FM without any guide for inference to obtain the FM output for the first request.

8. The system of claim 6, wherein said using the first FM for inference to obtain the first output for the first request and said storing the first request in the first storage as suitable for processing by the first FM comprise:
using the first FM without any guide for inference to obtain a third output for the first request;
if the third output is similar to the second output, storing the first request in the first storage as suitable for processing by the first FM; and
if the third output is not similar to the second output, performing the following steps:
obtaining a second guide for the first request,
using the first FM with the second guide for inference to obtain a fourth output for the first request, and
if the fourth output is similar to the second output, storing the first request in the first storage as suitable for processing by the first FM, and storing the second guide in the second storage.

9. The system of claim 8, wherein said obtaining the second guide for the first request comprises:
obtaining the second guide from the second storage for the first request; or
obtaining the second guide using a third FM for the first request, the third FM having a greater model size and/or capability than the first FM.

10. The system of claim 8, wherein the method further comprises:
if the fourth output is not similar to the second output, storing the first request in the first storage as suitable for processing by the second FM.

11. One or more non-transitory, computer-readable storage media comprising computer-executable instructions, wherein the instructions, when executed, cause one or more processors to perform the method of claim 1.

12. The one or more non-transitory, computer-readable storage media of claim 11, wherein said using the first FM for inference to obtain the FM output for the first request comprises:
if a first guide associated with the second request is found in a second storage, using the first FM with the first guide for inference to obtain the FM output for the first request; and
if no guide associated with the second request is found in the second storage, using the first FM without any guide for inference to obtain the FM output for the first request.

13. The one or more non-transitory, computer-readable storage media of claim 11, wherein said using the first FM for inference to obtain the first output for the first request and said storing the first request in the first storage as suitable for processing by the first FM comprise:
using the first FM without any guide for inference to obtain a third output for the first request;
if the third output is similar to the second output, storing the first request in the first storage as suitable for processing by the first FM; and
if the third output is not similar to the second output, performing the following steps:
obtaining a second guide for the first request,
using the first FM with the second guide for inference to obtain a fourth output for the first request, and
if the fourth output is similar to the second output, storing the first request in the first storage as suitable for processing by the first FM, and storing the second guide in the second storage.

14. The one or more non-transitory, computer-readable storage media of claim 13, wherein said obtaining the second guide for the first request comprises:
obtaining the second guide from the second storage for the first request; or
obtaining the second guide using a third FM for the first request, the third FM having a greater model size and/or capability than the first FM.

15. The one or more non-transitory, computer-readable storage media of claim 13, wherein the method further comprises:
if the fourth output is not similar to the second output, storing the first request in the first storage as suitable for processing by the second FM.

16. The one or more non-transitory, computer-readable storage media of claim 11, wherein the method further comprises:
using the second FM for inference to obtain the FM output for the first request if the second request is found and is suitable for processing by the second FM.

17. The one or more non-transitory, computer-readable storage media of claim 11, wherein the method further comprises:
prior to said searching for the second request similar to the first request, obtaining a routing decision for the first request;
wherein the routing decision is to use the second FM to obtain the FM output for the first request.

18. The one or more non-transitory, computer-readable storage media of claim 17, wherein said obtaining the routing decision for the first request comprises:
obtaining the routing decision for the first request using a static router.

19. The one or more non-transitory, computer-readable storage media of claim 11, wherein said similar refers to semantically similar.

20. The one or more non-transitory, computer-readable storage media of claim 11, wherein said similar is determined by a similarity comparison using a vector similarity method or a large-language-model (LLM) as a judge method.
